(19) United States
(12) Patent Application Publication
(10) Pub. No.: US 2026/0250104 A1
(43) Pub. Date: Aug. 27, 2026

(54) ELEVATOR CAR DOOR RESTRICTOR SOLENOID ASSEMBLY AND METHOD

(71) Applicant: Argus Elevator LLC, Kennesaw, GA (US)

(72) Inventors: Omar Gil-Arias, Atlanta, GA (US); Joel Gilmer, Roswell, GA (US)

(21) Appl. No.: 19/060,274

(22) Filed: Feb. 21, 2025

(51) Int. Cl. B66B 13/16

(52) U.S. Cl. CPC B66B 13/165

(57) ABSTRACT

A one-piece solenoid bracket includes a mounting web, the mounting web defining a first side and second side opposite the first side, a first mounting flange extending from the first side transversely to the mounting web, a second mounting flange extending from the second side substantially transversely to the mounting web, the second mounting flange defining a flange end and a slot, the slot configured to accommodate a solenoid, a retaining web extending from the flange end substantially transversely to the second mounting flange, the retaining web defining a distal end opposite the second mounting flange, and a retaining flange, the retaining flange extending from the distal end substantially transversely to the retaining web opposite the second mounting flange. The mounting web, the first mounting flange, the second mounting flange, the retaining web, and the retaining flange form a single piece of material.

### TECHNICAL FIELD

### Field Of Use

This disclosure relates to elevator systems. More specifically, this disclosure relates to a solenoid assembly that restricts movement of an elevator car door.

### Related Art

Elevator systems include an elevator door operator for each elevator car. The elevator door operator controls the opening and closing of an elevator door smoothly and consistently, coordinating with the elevator's movement to ensure that the door opens and closes at the appropriate times. FIG. 1 illustrates an example of a conventional elevator operator 10 mounted to a frame of an elevator car 20, with a conventional elevator car door restrictor solenoid assembly 30 mounted to an elevator car frame member 22 in a vertical orientation in operable proximity to the elevator operator 10. The door restrictor solenoid assembly 30 restricts the elevator car door 24 from opening more than a predetermined distance (such as four inches) when the elevator car 20 is outside a landing zone of a hoistway. For freight elevators, the landing zone typically measures eighteen inches above or below a floor of the building in which the elevator system is installed; for passengers, the landing zone distance is typically three inches instead of eighteen inches. By restricting the opening of the elevator car door 24 when positioned outside the landing zone, the door restrictor solenoid assembly 30 prevents any elevator car occupant from getting out of the elevator car 20 and falling down the hoistway. Of critical importance, it also prevents the occupant from getting partially out of the elevator car, having the car move again, and causing the occupant to get stuck between the moving car and the floor.

As best seen in FIG. 2A, the conventional elevator operator 10 comprises a motor 11 mounted on a support bracket 12, the motor 11 driving a motor drive shaft 11a around which is partially wrapped a first drive belt (or chain) 13a. The first drive belt 13a is also partially wrapped around the periphery of a first pulley 14, the first pulley 14 defining a hub 14a around which is partially wrapped a second drive belt (or chain) 13b. The second drive belt 13b is also partially wrapped around the periphery of a second pulley 15. The second pulley 15 can be rotatably mounted at its center 15a to an operator controller 16. The second pulley need not always be rotatably mounted to the operator controller 16 and may be instead rotatably mounted to another system element. The operator controller 16 manages the functions of the elevator operator 10, receiving signals from an elevator system controller to open or close the elevator car door 20 (FIG. 1). The first pulley 14 further defines a plurality of pulley holes such as at 14b,c, and the second pulley 15 further defines a plurality of pulley holes such as at 15b,c.

Referring again to FIG. 1, a first link 18a is pivotally mounted to the pulleys 14, 15 of the elevator operator 10. An end of the first link 18a is also pivotally connected to a second link 18b by means such as a pivot pin 19a. Proximate the opposite end of the second link 18b, specifically at pivot pin 19b, the second link 18b is also pivotally connected to a third link 18c. Opposite pivot pin 19b, specifically at pivot pin 19c, the third link 18c is also pivotally connected to a fourth link 18d. With this configuration, rotation of the pulleys 14, 15 causes the fourth link 18d to push or pull a bearing 26 connected to the elevator car door 24, along the line defining double arrow 28. A bracket 41 is connected at a lower end to the elevator car door 24 and at an upper end to a ramp 43.

Still referring to FIG. 1, the door restrictor solenoid assembly 30 includes a solenoid 32 supported by a solenoid mounting bracket 34 that is fastened or otherwise attached to the elevator car frame member 22. The solenoid 32 is provided with an externally-threaded lower reduced diameter portion (not shown) that extends through a hole in a lower mounting flange, with a nut 37 (FIG. 3A) threadably received on the reduced diameter portion to secure the solenoid 32 onto the solenoid mounting bracket 34. A solenoid plunger 38 is axially moveable within the solenoid 32, as indicated by the dual arrow 39. In the vertical orientation shown, when the solenoid 32 is energized, the solenoid plunger 38 moves from an extended position to a retracted position. When the solenoid 32 is de-energized, gravity returns the solenoid plunger 38 to a fully extended position, in which an end of the solenoid plunger 38 extends through the hollow externally-threaded lower reduced diameter portion of the solenoid 32. In that position, if the elevator car door 24, and thus also the bracket 41 fixed to it and the ramp 43 attached to the bracket 41, moves from right to left along double arrow 28 and an upper portion of the bracket 41 engages the extended lower end portion of the solenoid plunger 38, the extended plunger 38 prevents further travel of the elevator car door 24 from right to left. If, on the other hand, the elevator car door 24 moves from left to right such that at the start of the movement, the ramp 43 is positioned to the left of the extended plunger 38, then the ramp 43, once it engages the extended lower end of the solenoid plunger 38 during door movement, presses against the lower end of the solenoid plunger 38 to progressively push the solenoid plunger 38 upwardly into the solenoid 32 along the line of double arrow 39. Thus, the ramp 43 allows the elevator car door 24 to close even when there is no power. If the solenoid plunger 38 assumes a fully-retracted position, then the elevator car door 24 is free to move in either of the directions indicated by the double arrow 28.

Still referring to FIG. 1, the solenoid mounting bracket 34 includes a z-bracket 36 attached to an upper mounting bracket flange, with the upper end of the z-bracket 36 positioned in close proximity to the second drive belt 13b of the elevator operator 10. The z-bracket 36 prevents the solenoid plunger 38, and any elements that may be attached to the solenoid plunger 38 to form a plunger assembly, from falling out during packing, shipping, unpacking, transportation, and installation. This is an important benefit during installation, for example, because the solenoid mounting bracket 34 is shown installed on the frame member 22, which defines a top of the elevator car 20, and if the solenoid plunger or a plunger assembly were to fall from that height within the elevator car 20, it could sustain damage.

Sometimes, due to space limitations, it is desirable to mount the conventional elevator car door restrictor solenoid assembly 30 in a horizontal orientation, instead of in the vertical orientation illustrated in FIG. 1. Referring to FIGS. 2A and 2B, FIG. 2A is a partially exploded perspective view isolating the elevator operator 10, showing placement of the conventional elevator car door restrictor solenoid assembly 30 in operable proximity to the first pulley 14 of the elevator operator 10 when the conventional elevator car door restrictor solenoid assembly 30 is to be oriented horizontally, and FIG. 2B is a top perspective view of the elevator car door 24 and of the elevator operator 10 showing a region 31 of the support bracket 12 on which the conventional elevator car door restrictor solenoid assembly 30 would be installed in the horizontal orientation shown in FIG. 2A. Support bracket 12 is shown mounted to elevator car frame members 27,28. In the horizontal orientation shown in FIG. 2A, the conventional elevator car door restrictor solenoid assembly 30 must be provided with a spring (not shown). In conventional assemblies 30 with springs, such as one that had been sold by CJ Anderson, the solenoid plunger retracts when the solenoid is de-energized, owing to a pushing force of the spring, and the solenoid plunger is extended against the pushing force of the spring when energized. Other conventional spring-based designs use a solenoid operating under an opposite polarity, i.e., the solenoid plunger retracts when the solenoid 32 is energized, and extends (owing to the pulling force of the spring) when the solenoid 32 is de-energized. In either case, full extension of the solenoid plunger 38 causes an end of the plunger to protrude through the threaded reduced diameter portion of the solenoid 32 and move along axis 33 (FIG. 2A) until the plunger end passes through one of the holes (such as 14b or 14c) in the first pulley 14, thereby preventing further rotation of the first pulley 14 and thus preventing further opening of the elevator car door 24 (FIG. 1). Certain designs of conventional door restrictor assemblies 30 with springs present certain drawbacks. For instance, in the first of the two spring-based designs discussed above, a battery must keep the solenoid plunger 38 extended and the door closed, as the solenoid 32 must remain energized to do so. Furthermore, some building codes require the elevator car door 24 to retain the ability to close even when power is unavailable. The ramp 43 discussed above with regard to FIG. 1 enables this functionality for vertical orientations of the solenoid 32. However, in horizontal orientations involving the first of the spring-based designs described above, the solenoid 32 remains energized, and requiring continuous power to the solenoid 32 to keep the solenoid plunger 38 extended prevents the elevator car door 24 from meeting this requirement. Additional sensors, components, or controls would be needed to achieve compliance.

Referring to FIGS. 3A and 3B, FIG. 3A is a front perspective view of the conventional elevator car door restrictor solenoid assembly 30, showing additional features, and FIG. 3B is a side perspective view of a plunger assembly constructed in accordance with the conventional elevator car door restrictor solenoid assembly 30. The solenoid mounting bracket 34 is a channel-shaped piece comprising a mounting web 40, a lower mounting flange 42, and an opposed upper mounting flange 44, both of the flanges 42,44 oriented substantially transversely to the mounting web 40. The lower mounting flange 42 defines a lower flange hole (not shown) to accommodate the threaded reduced diameter portion, and the upper mounting flange 44 defines an upper flange hole (not shown) to accommodate an upper portion of the solenoid 32. The solenoid 32 is axially aligned with respect to the centers of the upper and lower flange holes, and then the solenoid 32 is inserted into the solenoid mounting bracket 34 through the upper flange hole. Electrical leads 46 communicate with the upper portion of the solenoid 32, such that current carried through the leads 46 energizes the solenoid 32.

A fastener 48, comprising a head 48a and a threaded shank 48b (FIG. 6A) extending from the head 48a partially into the solenoid 32, engages a fastener seat such as that shown at 138c (FIG. 8) formed into a proximal end of the solenoid plunger 38. Typically, the fastener 48 takes the form of a pan head screw. The fastener 48 further defines a distal end 48d opposite the head 48a. When fastened together in this manner, the solenoid plunger 38 and the fastener 48 are axially moveable as a unit inside the solenoid 32.

A spacer 47 (FIG. 3B) is seated on the plunger 38. The purpose of the spacer 47 is to limit travel of the solenoid plunger 38 in the retract direction. An annular reduced diameter portion 45 extends axially from an end of the spacer 47. The reduced diameter portion 45 can define a profile that is complimentary to a profile defined by a proximal end (not shown) of the solenoid plunger 38, thus facilitating proper axial alignment between the spacer 47 and the solenoid plunger 38. The spacer 47 assumes the shape of an annular cylinder, defining a central bore (similar to the bore 847c in an alternate plunger assembly 800, to be described herein with regard to FIG. 8), through which the threaded shank 48b of the fastener 48 passes in an assembled state of the conventional elevator car door restrictor solenoid assembly 30. Typically, both the solenoid plunger 38 and the spacer 47 are constructed of metal.

Referring again to FIGS. 3A-6A, a washer 50 is seated on the upper portion of the spacer 47 and a bonded washer 52 sits atop the washer 50. The washer 50 is typically constructed of rubber to dampen vibration and to allow it to conform responsive to the compressive force transmitted to it by the bonded washer 52 when the conventional plunger assembly 49 is in a tightened state, namely, when the threaded shank 48b of the fastener 48 fully engages a threaded fastener seat formed on the upper end of the solenoid plunger 38. A cap 51 can sit atop an upper end of the solenoid 32 and be held in place there by friction between the cap 51 and an outer wall of the solenoid 32. Optionally, an adhesive may be used to enhance the engagement between the cap 51 and the solenoid 32. The purpose of the cap 51 is to provide a soft surface for the washer 50 to contact during operation of the solenoid. This cushioning reduces wear and noise that would otherwise occur during such operation. Once the fastener 48 is fully tightened with respect to the plunger 38 in the manner described above, the bonded washer 52 axially restrains the washer 50, confining the washer 50 to the axial space between the bonded washer 52 and the upper end of the spacer 47. The bonded washer 52 is typically composed of a metal bonded to rubber and helps to shield the washer 50 from damage that it would otherwise sustain from the fastener head 48a if the fastener head 48a were permitted to directly contact the washer 50 upon tightening.

When the fastener 48 fully attaches the spacer 47 to the solenoid plunger 38, the resulting spacer-plunger combination defines a moving assembly. As best seen in FIG. 3A, the conventional elevator car door restrictor solenoid assembly 30 defines a total moving assembly height H1, measured from the bottom end 38a of the solenoid plunger 38 to the top of the fastener head 48a Stated another way, the total moving assembly height H1 equals a plunger assembly height H3 (FIG. 3B) plus the height of the plunger 38, which can approximate the length L1 of a corresponding plunger 138 in the alternate embodiment to be described with regard to FIG. 8. A typical magnitude for the total moving assembly height H1 is approximately 92.1 mm.

Since, as discussed above, the solenoid plunger 38 and the fastener 48 are axially moveable as a unit inside the solenoid 32 in the assembled state of the elevator car door restrictor solenoid assembly 30, the spacer 47, by virtue of its attachment to the solenoid plunger 48, is likewise axially moveable together with the solenoid plunger 48 as a unit inside the solenoid 32. In a vertical orientation of the assembly 30, upward axial travel of the spacer-plunger unit can halt when the upward force of the solenoid 32 equals the combined forces of friction on the spacer-plunger unit plus gravitational force. Downward axial travel of the spacer-plunger unit stops when the washer 50 hits the cap 51.

Once the solenoid 32 is seated in the solenoid mounting bracket 34 as shown in FIG. 3A, the z-bracket 36 is attached to the upper mounting flange 44. The z-bracket 36 can be a single bar or strip of metallic material bent into a “z” shape to form a web 54, a lower z-bracket flange 56 extending transversely outwardly from a lower bend of the web 54, and an upper z-bracket flange 58 extending transversely inwardly from an upper bend of the web 54. A fastener such as a screw 60 passes through the lower z-bracket flange 56 and through the upper mounting flange 44, then a nut 62 is threaded onto the lower end of the screw 60 to secure the z-bracket 36 to the solenoid mounting bracket 34. Thus, the conventional combined bracket assembly is comprised of four parts: the solenoid mounting bracket 34, the z-bracket 36, the screw 60, and the nut 62. In this fastened position, the conventional elevator car door restrictor solenoid assembly 30 defines a total bracket height H2 measured from the underside 42a of the lower mounting flange 42 to a top surface of the upper z-bracket flange 58. A typical magnitude for H2 measures approximately 91.2 mm.

The design of the conventional elevator car door restrictor solenoid assembly 30 presents inconvenience if one must replace a plunger assembly connected to the solenoid plunger 38, because before such replacement may occur, the z-bracket 36 must be removed from the solenoid mounting bracket 34. Additional drawbacks presented by this design are that the solenoid mounting bracket 34 needs to possess a certain minimum: (i) width (typically approximately 63.6 mm) to better accommodate screw 60 and the nut 62, and (ii) height to accommodate a plunger assembly that must likewise possess a certain minimum plunger assembly height H3 (FIG. 3B). As shown in FIG. 3B, plunger assembly height H3 denotes the combined height of the spacer 47, washer 50, bonded washer 52, and fastener head 48a of the conventional plunger assembly 49. Plunger assembly height H3, typically measuring approximately 28.4 mm, must be large enough to: (i) accommodate a minimum thickness of the washer 50 that allows the washer 50 to be stiff and sufficiently strong to resist breakage; (ii) include the bonded washer 52 because the bonded washer 52 is needed to more evenly distribute a holding force from the fastener (SCHS) head 48a to the washer 50; and (iii) accommodate the height of the head 48a because neither the washer 50 nor the bonded washer 52 have a countersink in which the head 48a could be seated.

### SUMMARY

It is desirable to devise an elevator car door restrictor solenoid assembly that can overcome the difficulties and drawbacks discussed above with regard to conventional door restrictor solenoid assemblies. In embodiments of the present disclosure, a mounting bracket is composed of a single piece of material, which reduces bracket component count and minimizes accumulation of height tolerance deviations, thereby minimizing variation of the total height of the bracket.

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a one-piece solenoid bracket comprising a mounting web, the mounting web defining a first side and second side opposite the first side, a first mounting flange extending from the first side substantially transversely to the mounting web, a second mounting flange extending from the second side substantially transversely to the mounting web, the second mounting flange defining a flange end and a slot, the slot configured to accommodate a solenoid, a retaining web extending from the flange end substantially transversely to the second mounting flange, the retaining web defining a distal end opposite the second mounting flange, and a retaining flange, the retaining flange extending from the distal end substantially transversely to the retaining web opposite the second mounting flange, wherein the mounting web, the first mounting flange, the second mounting flange, the retaining web, and the retaining flange form a single piece of material.

In a further aspect, disclosed is a solenoid plunger assembly, comprising a spacer body defining a first end, an opposed second end, and an axial bore extending from the first end to the second end, and a head extending radially outwardly from the spacer body proximate the first end; and a fastener extending through the axial bore, the fastener defining external threads configured to threadably engage a seat formed into an end of a solenoid plunger positioned within a solenoid.

In a still further aspect, disclosed is an elevator car door restrictor solenoid assembly, comprising a one-piece solenoid bracket comprising a mounting web, the mounting web defining a first side and second side opposite the first side, a first mounting flange extending from the first side substantially transversely to the mounting web, a second mounting flange extending from the second side substantially transversely to the mounting web, the second mounting flange defining a flange end and a slot, a retaining web extending from the flange end substantially transversely to the second mounting flange, the retaining web defining a distal end opposite the second mounting flange, and a retaining flange, the retaining flange extending from the distal end substantially transversely to the retaining web opposite the second mounting flange, wherein the mounting web, the first mounting flange, the second mounting flange, the retaining web, and the retaining flange form a single piece of material; a solenoid positioned within the slot defined in the second mounting flange; a plunger axially moveable within the solenoid, the plunger defining an end, the end defining a fastener seat; and a plunger assembly comprising a spacer comprising a spacer body defining a first end, an opposed second end, and an axial bore extending from the first end to the second end, and a head extending radially outwardly from the spacer body proximate the first end; and a fastener extending through the axial bore, the fastener defining an externally-threaded end portion threadably engaging the fastener seat of the plunger.

In a still further aspect, disclosed is a method of assembling an elevator car door restrictor solenoid assembly, comprising the steps of partially inserting a externally-threaded 48 of a solenoid partially through a hole of a one-piece solenoid bracket, the one-piece solenoid bracket comprising a mounting web, the mounting web defining a first side and second side opposite the first side, a first mounting flange extending from the first side substantially transversely to the mounting web, the first mounting flange defining the hole through which the externally-threaded reduced diameter portion of the solenoid is partially inserted, a second mounting flange extending from the second side substantially transversely to the mounting web, the second mounting flange defining a flange end and a slot, a retaining web extending from the flange end substantially transversely to the second mounting flange, the retaining web defining a distal end opposite the second mounting flange, and a retaining flange, the retaining flange extending from the distal end substantially transversely to the retaining web opposite the second mounting flange, wherein the mounting web, the first mounting flange, the second mounting flange, the retaining web, and the retaining flange form a single piece; orienting the solenoid at an angle with respect to the mounting web; exerting force upon the solenoid sufficient to position it within the slot of the second mounting flange and to orient an axis of the solenoid substantially parallel to a plane at least partially defined by the mounting web; substantially completely inserting the externally-threaded reduced diameter portion of the solenoid through the hole of the one-piece solenoid bracket; and mounting a nut upon a portion of the externally-threaded reduced diameter portion of the solenoid extending through the hole of the one-piece solenoid bracket.

Various implementations described in the present disclosure can comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is a perspective view of an elevator operator mounted to a frame of an elevator car, with a conventional elevator car door restrictor solenoid assembly mounted to a frame member in a vertical orientation in operable proximity to the elevator operator.

FIG. 2A is a partially exploded perspective view isolating the elevator operator of FIG. 1, showing placement of a conventional elevator car door restrictor solenoid assembly in operable proximity to a pulley of the elevator operator when the conventional elevator car door restrictor solenoid assembly is to be oriented horizontally.

FIG. 2B is a top perspective view of the elevator car door and of the elevator operator of FIG. 1, showing a region of a support bracket of the elevator operator on which the conventional elevator car door restrictor solenoid assembly would be installed in the horizontal orientation shown in FIG. 2A.

FIG. 3A is a front perspective view of the conventional elevator car door restrictor solenoid assembly illustrated in FIG. 2A.

FIG. 3B is a side perspective view of a plunger assembly constructed in accordance with the conventional elevator car door restrictor solenoid assembly illustrated in FIG. 2A FIG. 3C is sectional view of a fastener used in the plunger assembly illustrated in FIG. 3B.

FIG. 4 is a front perspective view of an elevator car door restrictor solenoid assembly constructed in accordance with an aspect of the current disclosure.

FIGS. 5A-5D are side perspective views illustrating sequential steps performed to assemble a solenoid onto a one-piece solenoid bracket constructed in accordance with an aspect of the current disclosure.

FIG. 6A is a sectional view of a socket head cap screw used an elevator car door restrictor solenoid assembly constructed in accordance with an aspect of the current disclosure.

FIGS. 6B-6E are front perspective views illustrating sequential steps performed to attach a plunger assembly to a plunger axially moveable with respect to the solenoid illustrated in FIGS. 5A-5D.

FIG. 7 is a side perspective view illustrating, at left, the plunger assembly used in the conventional elevator car door restrictor solenoid assembly illustrated in FIG. 3A, in juxtaposition to, at right, a plunger assembly used in the elevator car door restrictor solenoid assembly of FIG. 4, constructed in accordance with an aspect of the current disclosure.

FIG. 8 is an exploded sectional view of a plunger assembly constructed in accordance with another aspect of the current disclosure, showing exploded positioning of a spring relative to a spring engagement section of the plunger assembly.

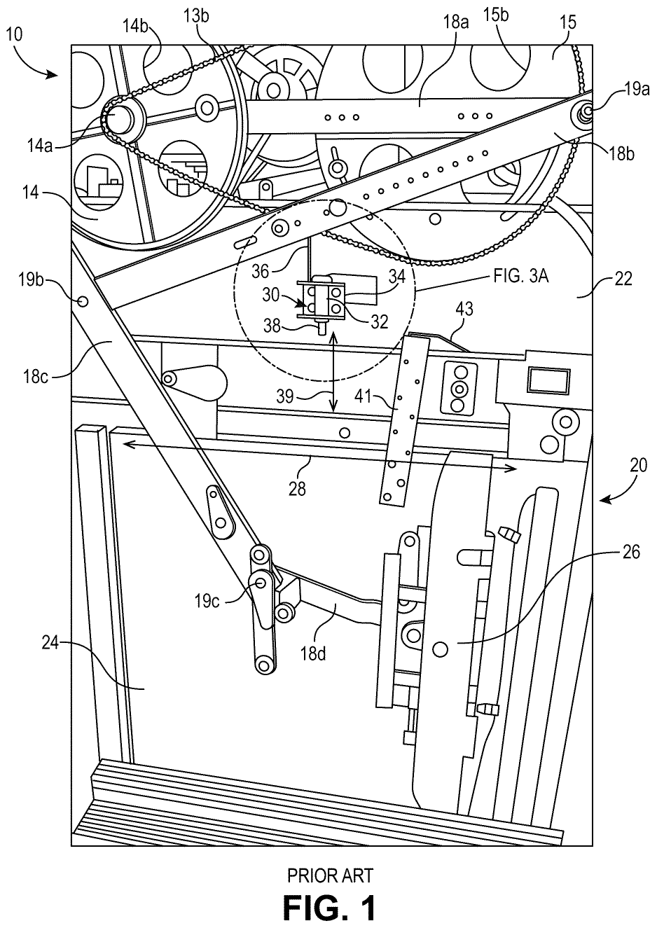

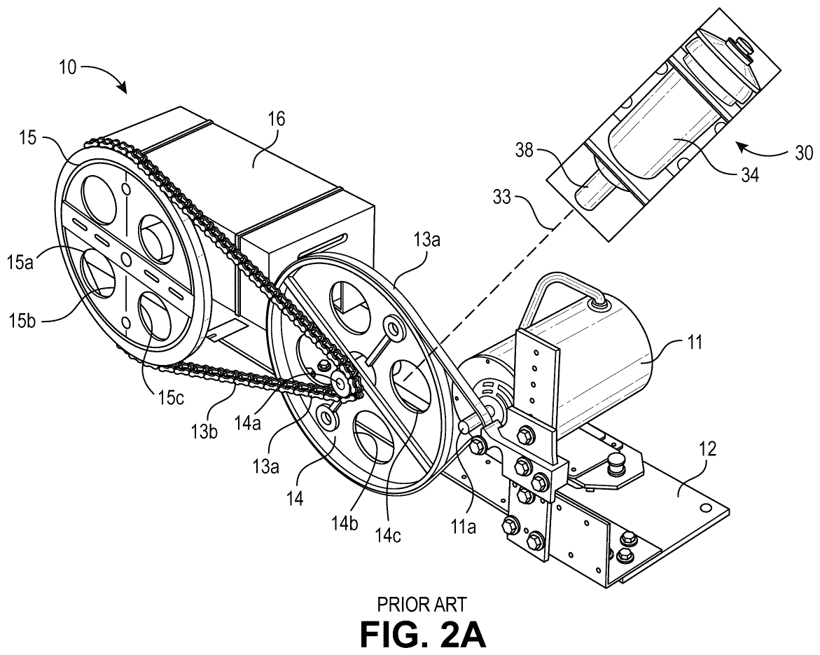

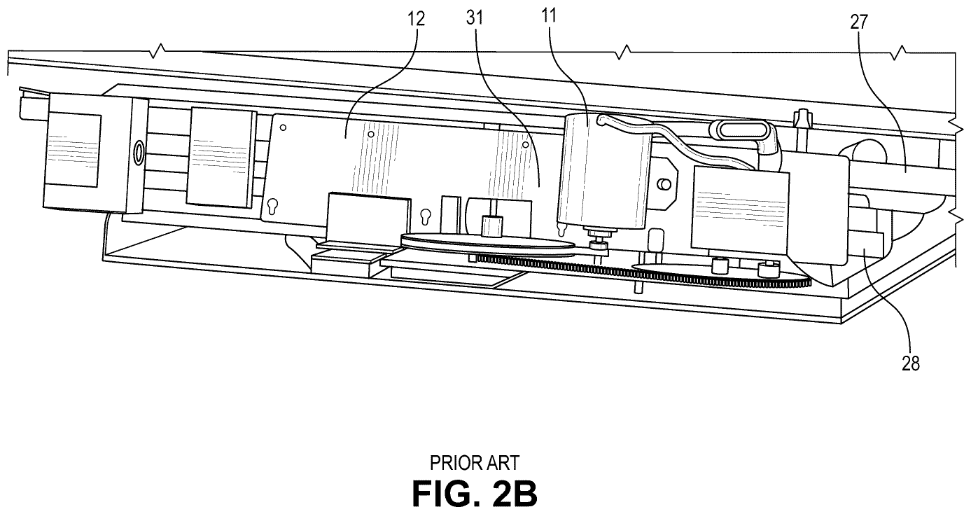

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

To simplify the description of various elements disclosed herein, the conventions of “top,” “bottom,” “side,” “upper,” “lower,” “horizontal,” and/or “vertical” may be referenced.

Unless stated otherwise, “top” describes that side of the system or component that is facing upward and “bottom” is that side of the system or component that is opposite or distal the top of the system or component and is facing downward. Unless stated otherwise, “side” describes that an end or direction of the system or component facing in horizontal direction. “Horizontal” or “horizontal orientation” describes that which is in a plane aligned with the horizon. “Vertical” or “vertical orientation” describes that which is in a plane that is angled at 90 degrees to the horizontal.

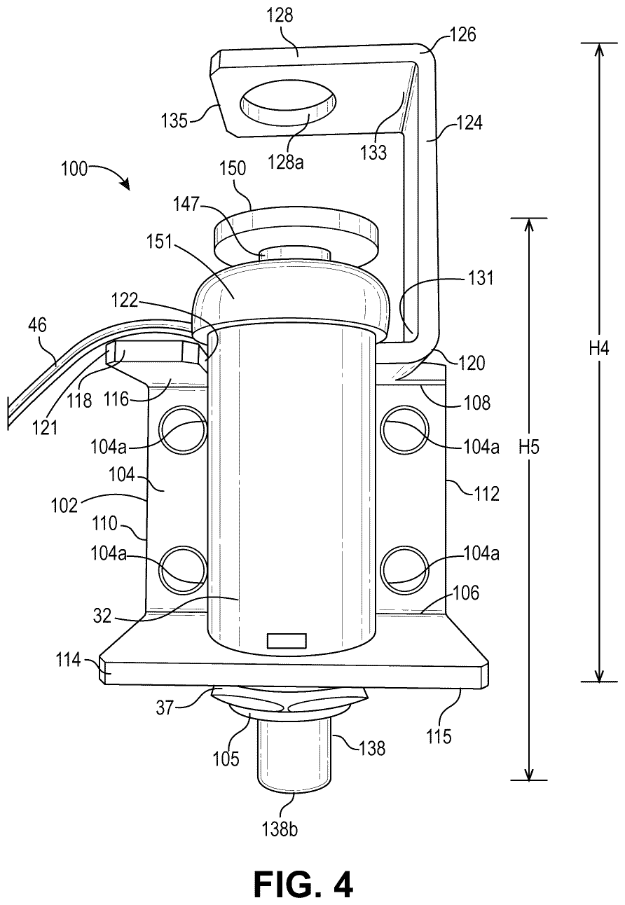

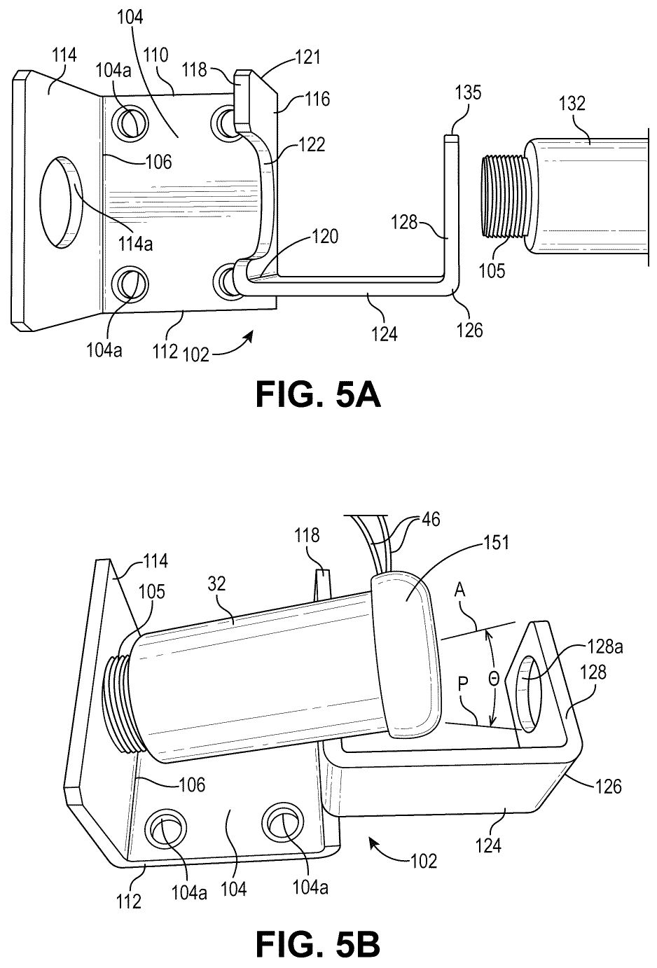

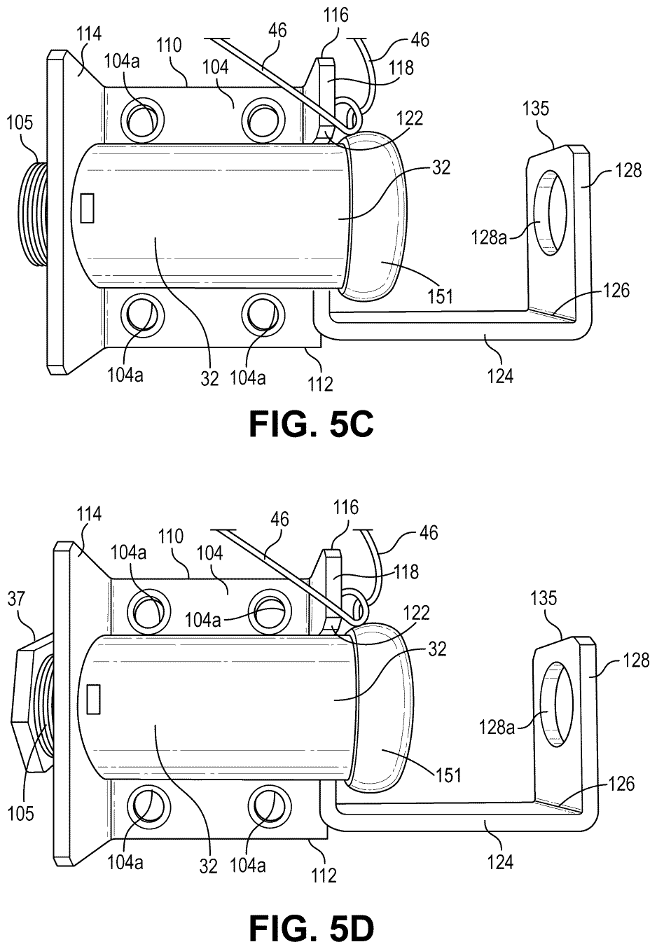

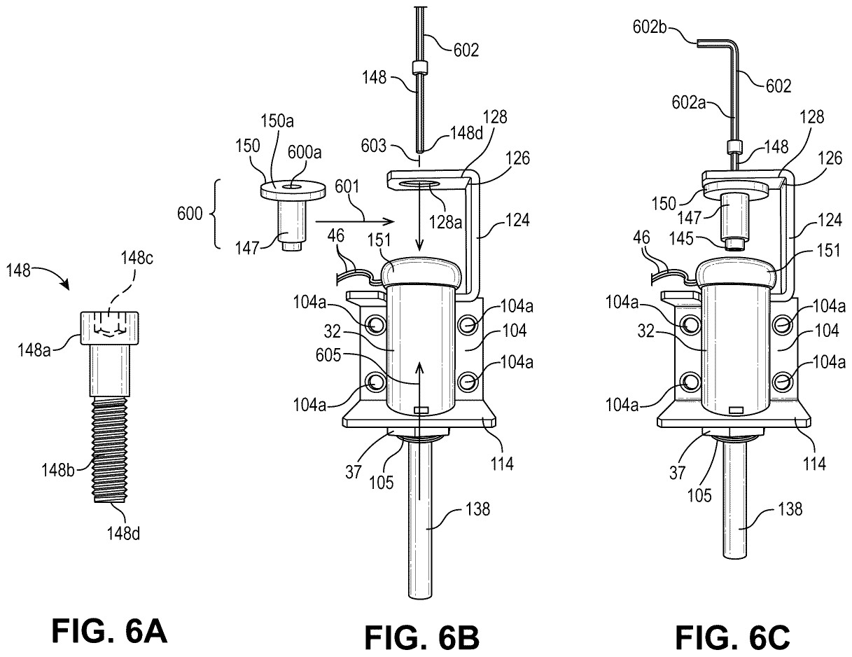

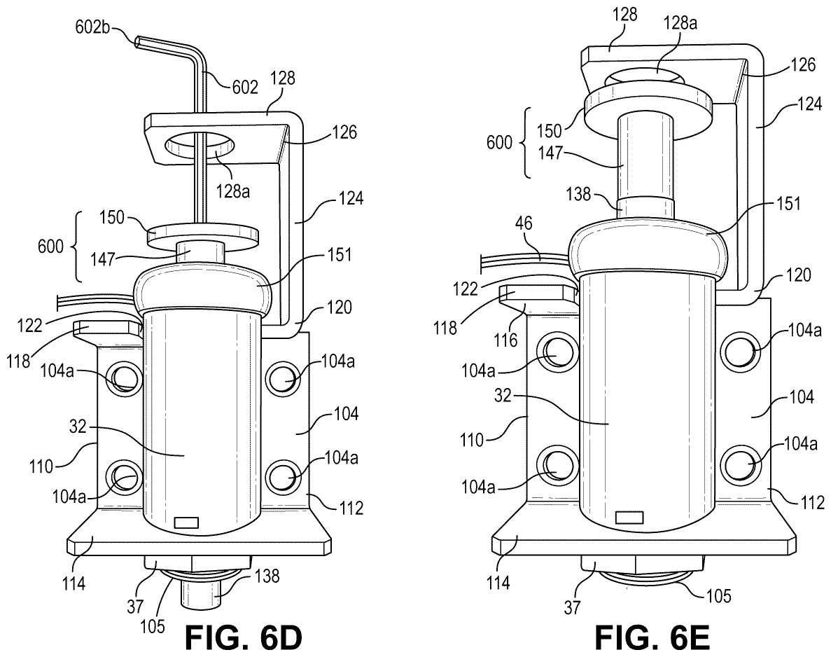

FIG. 4 is a front perspective view of an elevator car door restrictor solenoid assembly 100 constructed in accordance with an aspect of the current disclosure. The assembly 100 includes a one-piece solenoid bracket 102 comprising a mounting web 104, the mounting web 104 defining opposed sides 106,108 and 110,112, as well as at least one mounting hole 104a to accommodate fasteners (not shown). Although FIG. 4 illustrates four mounting holes 104a, this is only meant to be exemplary and not limiting, and the mounting web 104 can therefore define any suitable number of mounting holes 104a. A first mounting flange 114 extends from the first side 106 substantially transversely to the mounting web 104, and a second mounting flange 116 extends from the second side 108 substantially transversely to the mounting web 104. The second mounting flange 116 defines a front flange end 118, a first side flange end 120, a second side flange end 121 opposite the first side flange end 120, and a slot 122, the slot 122 configured to accommodate a solenoid 32. As best seen in FIG. 5A, the slot 122 can be substantially U-shaped, projecting inwardly from the front flange end 118. However, the substantial U shape is merely exemplary and is not intended to be limiting, such that the slot 122 may assume other shapes that are suitable for allowing the solenoid 32 to be assembled into the one-piece solenoid bracket 102. A retaining web 124 extends from the first side flange end 120 substantially transversely to the second mounting flange 116, the retaining web 124 defining a distal end 126 opposite the second mounting flange 116. The one-piece solenoid bracket 102 further includes a retaining flange 128 extending from the distal end 126 substantially transversely to the retaining web 124 opposite the second mounting flange 116. The retaining flange 128 can define a tool aperture 128a, the tool aperture 128a configured to accommodate a spacer attachment tool 130 (FIGS. 6B-6D), the spacer attachment tool configured to attach a spacer to an end of a plunger positioned inside the solenoid. The retaining flange 128 can also define a free retaining flange end 135 opposite the fold line 133.

The mounting web 104, the first mounting flange 114, the second mounting flange 116, the retaining web 124, and the retaining flange 128 preferably form a single piece of material. In particular, a single plate-shaped piece of material, preferably a metal (such as steel, though other suitable types of metals could be used) can be bent at various bend lines to result in the aforementioned webs and flanges comprising the one-piece solenoid bracket 102. For example, a first bend line 131 can define the first flange end 120 of the second mounting flange 116, the first bend line 131 extending between the second mounting flange 116 and the retaining web 124, and a second bend line 133 can define the distal end 126 of the retaining web 124, the second bend line 133 extending between the retaining web 124 and the retaining flange 128. The one-piece solenoid bracket 102 defines a total bracket height H4 measured from the underside 115 of the first mounting flange 114 to a top surface of the retaining flange 128. In some embodiments, the total bracket height H4 can measure approximately 81.4 mm, though this magnitude is not intended to be limiting. Lines described herein as “bend lines” are to be broadly construed as lines about which adjacent panels (such as flanges or webs of the brackets disclosed herein) bend relative to one another. The term “bend lines” in therefore to be distinguished from narrower terms, such as creases or scores that denote a physical feature (such as a sharp corner) formed in the material being bent. Even bend lines depicted in the foregoing figures as solid lines should not be read as denoting a physical feature in the material being bent.

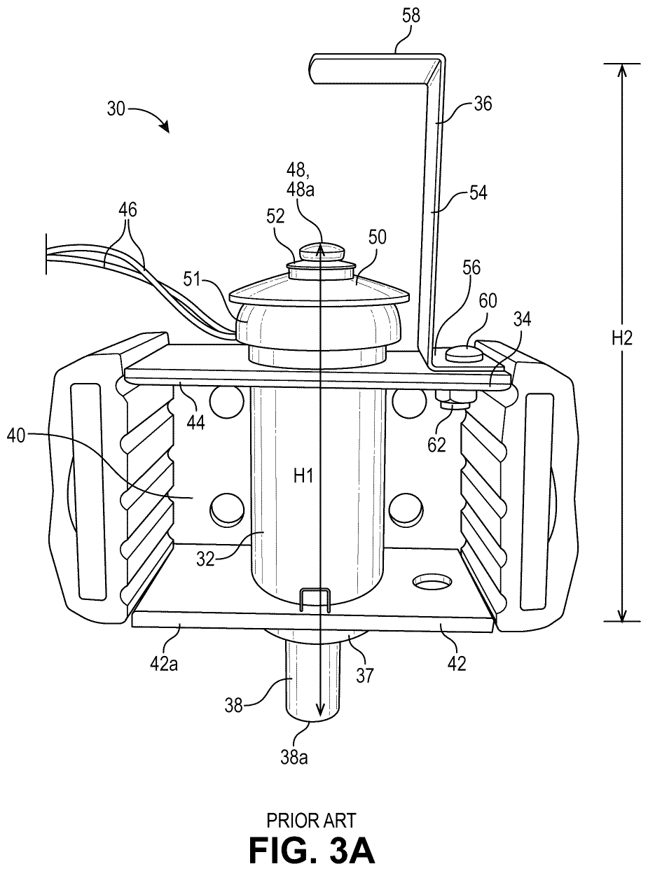

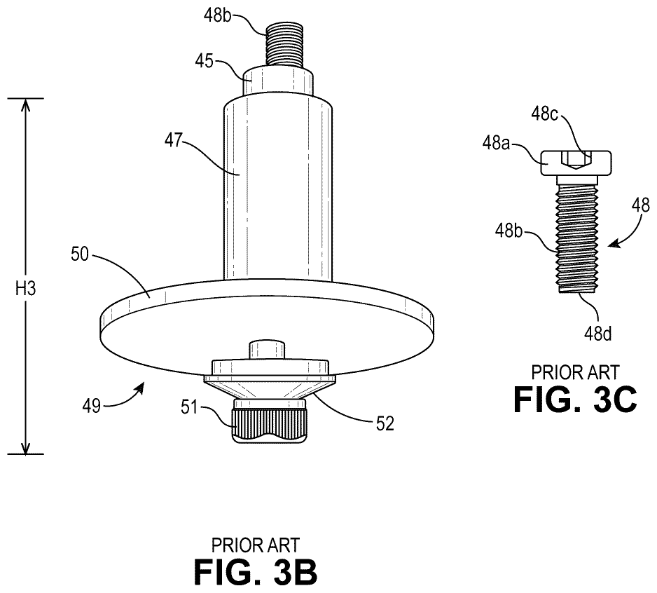

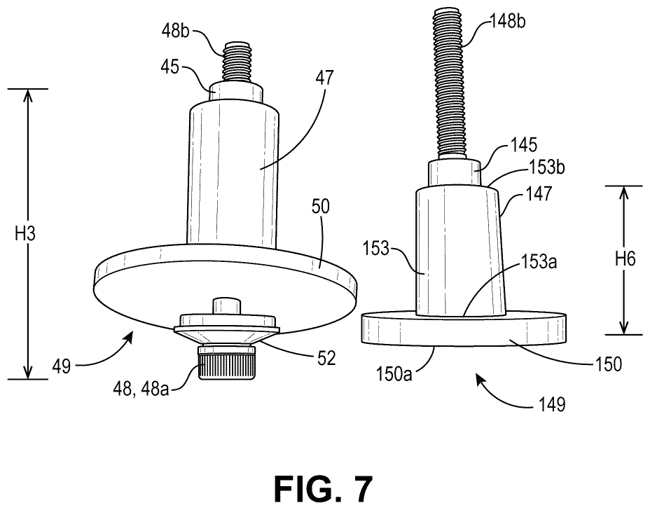

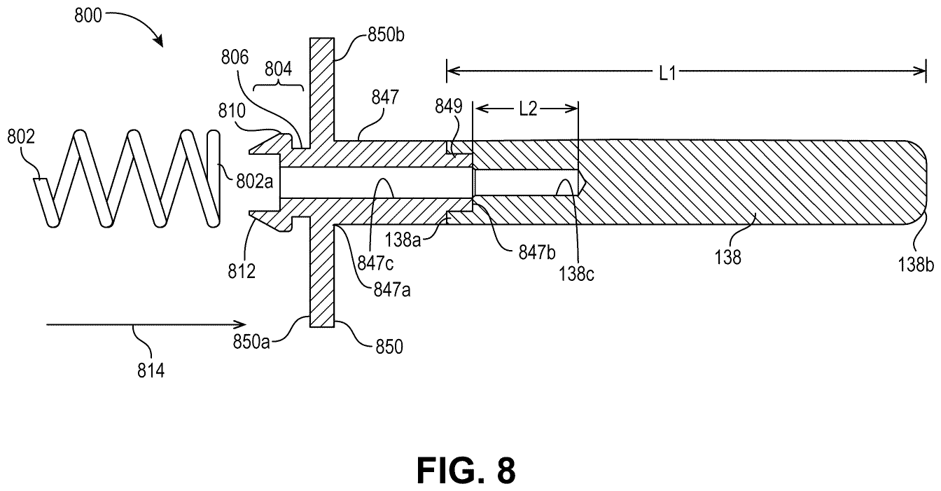

Referring to FIGS. 4 and 8, the elevator car door restrictor solenoid assembly 100 includes the solenoid 32 positioned within the slot 122 defined in the second mounting flange 116. Solenoid 32 defines an externally-threaded reduced diameter portion 105 axially extending from the main body of the solenoid 32 and, in the assembled state shown, through a mounting hole 114a (FIG. 5A) defined in the first mounting flange 114 of the one-piece solenoid mounting bracket 102. The nut 37 can be threadably received onto the externally-threaded reduced diameter portion 105 to secure the solenoid 32 onto the first mounting flange 114. Electrical leads 46 communicate with a cap 151 seated on an upper end of the solenoid 32. The cap 151 is can be constructed similarly to the cap 51 of FIG. 3A, except that a side wall of the cap 151 can define a slot (not shown) extending from a bottom edge of the cap 151 toward the top of the cap 151, and that the side wall of the cap 151 can have a height greater than the side wall height of the cap 51. These modifications make it less likely for the cap 151 to fall off and yet provide a greater clearance through which to connect the electrical leads 46 to the solenoid 32. A solenoid plunger 138 is axially moveable within the solenoid 32 responsive to current received through the electrical leads 46. The solenoid plunger 138 can be constructed identically to the conventional solenoid plunger 38 (FIG. 3A), except that the solenoid plunger 138 can be provided with a surface finish and coating that allow a cross-sectional diameter of the plunger 138 to be approximately equal to a cross-sectional diameter of the spacer body 147. This helps to prevent the occurrence of accelerated wear upon the bottom end (second end 153b in FIG. 7) of the spacer body 147. The solenoid plunger 138 defines a proximal end 138a, the proximal end 138a defining a fastener seat 138c. The solenoid plunger 138 further defines a distal end 138b opposite the proximal end 138a.

Referring to FIGS. 4 and 7, the elevator car door restrictor solenoid assembly 100 further includes a plunger assembly 149, the plunger assembly 149 including a spacer 147, a head 150, and a fastener (SHCS) 148. The spacer 147 includes a spacer body 153 defining a first end 153a, an opposed second end 153b, and an axial bore extending from the first end 153a to the second end 153b. The axial bore may be configured similarly to the axial bore 847c shown in the embodiment discussed herein with regard to FIG. 8. The head 150 of the plunger assembly 149 extends radially outwardly from the spacer body 153 proximate the first end 153a. This configuration can result from either the head 150 and the spacer 147 being integrally formed from a single piece of material, or from the head 150 being a separate annular disc-shaped piece fixedly joined to the first end 153a of the spacer body 153. The fastener (SHCS) 148 can extend through the axial bore defined by the spacer body 153, with its externally-threaded end portion 148b threadably engaging the fastener seat of the plunger 138. In the configuration shown in FIG. 4, the elevator car door restrictor solenoid assembly 100 defines a total moving assembly height H5, measured from the bottom end 138b of the solenoid plunger 138 to the top of the head 150. In some embodiments, the total moving assembly height H5 can measure approximately 82.2 mm, which is less than the conventional total moving assembly height H1 (FIG. 3A) of 92.1 mm. The stated magnitude for height H5 s not intended to be limiting, though it is preferably smaller than height H1.

FIGS. 5A-5D are side perspective views illustrating sequential steps performed to assemble the solenoid 32 onto the one-piece solenoid bracket 102. In FIG. 5A, the one-piece solenoid bracket 102 and the solenoid 32, defining the externally-threaded reduced diameter portion 105, are merely shown in exploded relation to one other. FIG. 5B shows the solenoid 32 as having been partially inserted through a hole of the one-piece solenoid bracket 102, namely, through the mounting hole 114a defined in the first mounting flange 114. FIG. 5B also shows the solenoid 32 being oriented at an angle e with respect to the mounting web 104. More particularly, the solenoid 32 defines a longitudinal axis of symmetry A, which in the position of FIG. 5B, forms the angle O with respect to a line P that is coplanar with respect to a plane containing every point of the mounting web 114, in other words, with respect to a plane at least partially defined by the mounting web 114. The solenoid 32 need not always be oriented at an angle when being inserted into the one-piece solenoid bracket 102. In many cases, however, the angular orientation may help facilitate such insertion. Next, FIG. 5C shows the result of exerting force upon the solenoid 32 sufficient to position it within the slot 122 of the second mounting flange 116 and to orient the axis A of the solenoid 32 substantially parallel to the aforementioned a plane, and therefore substantially parallel to the mounting web 114. In this position, the externally-threaded reduced diameter portion 105 of the solenoid 32 is substantially completely inserted through the mounting hole 114a defined in the first mounting flange 114. Finally in FIG. 5D, the nut 37 is mounted upon a portion of the externally-threaded reduced diameter portion 105 that extends through the mounting hole 114a.

FIG. 6A fully illustrates the fastener 148 used in the elevator car door restrictor solenoid assembly 100. The fastener 148 preferably takes the form of a socket head cap screw (SHCS), although the choice of a SHCS is not intended to be limiting, such that other types of suitable fasteners (including but not limited to the pan head screw illustrated in FIG. 3C) may be used in the assembly 100. The fastener (SHCS) 148 includes a head 148a and a threaded shank 148b extending from the head 148a and partially extending into the solenoid 32, where it engages a fastener seat such as that shown at 138c (FIG. 8) formed into a proximal end of the solenoid plunger 138. The fastener (SHCS) 148 further defines a distal end 148d opposite the head 148a. The head 148a defines a tool socket 148c therein to facilitate engagement of the fastener (SHCS) 148 by a spacer attachment tool 602, described below with regard to FIGS. 6B-6D.

FIGS. 6B-6E are front perspective views illustrating sequential steps performed to attach the plunger assembly 149 (FIG. 7) to the solenoid plunger 138. These figures illustrate a spacer 600 that comprises the above-described combination of the spacer body 147 and head 150.

As best seen in FIG. 6B, the spacer 600 defines an axial bore 600a, originating at an opening in a top surface 150a of the spacer head 150, configured to accommodate the fastener (SHCS) 48. The spacer attachment tool 602 is configured to attach the spacer 600 to the proximal end 138a (FIG. 8) of the plunger 138. A lower end of the spacer attachment tool 602 engages the tool socket 148c (FIG. 6A) defined in the head 148a of the fastener (SHCS) 148, such that a shank 602a of the spacer attachment tool 602 and the fastener (SHCS) 148 are substantially colinear, as shown in FIG. 6B. The spacer 600 is moved in the direction of arrow 601 until the spacer 600 is disposed between the cap 53 of the solenoid 32 and the retaining flange 128, such that substantial coaxial alignment is attained between the axial bore 600a of the spacer 600 and the tool aperture 128a of the retaining flange 128. Next, the spacer attachment tool 602 and the fastener (SHCS) 148 begin to be advanced axially downwardly in the direction of arrow 603, while the plunger 138 is moved upwardly in the direction of arrow 605.

In FIG. 6C, using the spacer attachment tool 602, the fastener (SHCS) 148 is inserted through the tool aperture 128a of the retaining flange 128, and then through the axial bore 600a of the spacer 600. The plunger 138 is also shown assuming a more upward position than the fully-extended position of FIG. 6B. As best seen in FIG. 6C, the spacer 600 can also define a reduced diameter portion 145 extending from the spacer body 147. The reduced diameter portion 145 can define a profile that is complimentary to a profile defined by the proximal end 138a (FIG. 8) of the solenoid plunger 138, thus facilitating proper axial alignment between the spacer 600 and the solenoid plunger 138. Also shown in FIG. 6C is a user handle 602b defined at the upper end of the spacer attachment tool 602.

In FIG. 6D, the fastener (SHCS) 148 is no longer visible because it has been driven through the axial bore 600a of the spacer, with its lower threaded end 148b (FIG. 6A) extending into the solenoid 32. The plunger 138 is also shown assuming an even more upward position than the partially-retracted position of FIG. 6C. In this manner, the lower threaded end 48b of the fastener (SHCS) 148 and the proximal end 138a (FIG. 8) of the solenoid plunger 138 can be brought into initial engagement with one another inside the solenoid 32. Continued rotation of the spacer attachment tool 602 via its handle 602 results in the position shown in FIG. 6E, described below.

In FIG. 6E, the solenoid plunger 138 and the spacer 600 are now fully attached to one another, such they are now capable of moving axially together as a unit. Threadable engagement has occurred between the lower threaded end 148b of the fastener (SHCS) 148 and the fastener seat 138c (FIG. 8) of the solenoid plunger 138. In the particular position shown in FIG. 6E purely for illustrative purposes the plunger 138 is in a fully-retracted position, and only the upper portion of the solenoid plunger 138 is visible in this position.

FIG. 7 is a side perspective view illustrating, at left, the conventional plunger assembly 49 discussed above with regard to FIG. 3A, in juxtaposition to, at right, the plunger assembly 149 used in the elevator car door restrictor solenoid assembly 100 (FIG. 4), constructed in accordance with an aspect of the current disclosure. This juxtaposition shows the reduction in height between the larger value H3 of the conventional assembly 49 and the smaller value H6 of the plunger assembly 149, the plunger assembly height H6 measured from the top surface 150a of the head 150 to the second end 153b of the spacer body 153. As mentioned above, height H3 typically measures approximately 28.4 mm, whereas in some embodiments, height H6 can measure only about 18.5 mm, though this magnitude is not intended to be limiting. This reduction in height between the respective plunger assemblies 49,149 allows for reduction in overall height between the conventional elevator car door restrictor solenoid assembly 30 (height H2 in FIG. 3A) and the elevator car door restrictor solenoid assembly 100 of the present disclosure (height H4 in FIG. 4).

FIG. 8 is a sectional view of a plunger assembly 800 constructed in accordance with another aspect of the current disclosure, showing exploded positioning of a spring 802 relative to a spring engagement section 804 of the plunger assembly 800. The plunger assembly 800 includes a spacer portion 847, a shelf (or head) 850, and the same fastener (SHCS) 148 described above with regard to FIG. 7. The spacer portion 847 defines a first end 847a, an opposed second end 847b, and an axial bore 847c extending from the first end 847a to the second end 847b. In some embodiments, the spacer portion 847 can define a reduced diameter section 849 having a smaller diameter than the remainder of the spacer portion 847. A profile of the reduced diameter section 849 may be complementary to a profile of a proximal end 138a of a solenoid plunger 138 having a plunger length L1. The proximal end 138a is positioned opposite a distal end 138b of the solenoid plunger 138. In a fully assembled state, the fastener (SHCS) 148 extends through the spring 802 and through the axial bore 847, such that the externally-threaded portion of the fastener (SHCS) 148 threadably engages a fastener seat 138c defined by the proximal end 138a of a solenoid plunger 138, the fastener seat 138c having a length L2. In some assembly methods, the attachment of the fastener (SHCS) 148 to the solenoid plunger 138 can occur prior to attaching the spring 802 to the spring engagement section 804 of the plunger assembly 800 in the manner described below. The shelf 850 of the plunger assembly 800 extends radially outwardly from the spacer portion 847 proximate the first end 847a. This configuration preferably results from the shelf 850 and the spacer portion 847 being integrally formed from a single piece of material. In this assembly, the shelf 850 defines a front surface 850a and an opposed rear surface 850b.

Still referring to FIG. 8, the spring engagement section 804 includes an axial extension 806 extending axially from the front surface 850a of the shelf 850 and a boss 808 extending radially outwardly from the axial extension 806 opposite the front surface 850a of the shelf 850. The axial extension 806, the boss 808, and the front surface 850a of the shelf 850 together define a circumferential groove of the spring engagement section 804. The boss 808 radially terminates in a circumferential shoulder 810. The boss 808 further defines a sloped profile 812 extending radially inwardly from the circumferential shoulder 810. The sloped profile 812 configured to allow, during manufacture of the plunger assembly 800, a leading end 802a of the spring 802 to move substantially axially in the direction of arrow 814 relative to the boss 808 and to engage the leading end 802a. Continued relative movement of the leading end 802a, in the direction of arrow 814, along the sloped profile 812 causes the leading end 802a to radially expand until the leading end 802a finishes moving along the sloped profile 812 and becomes seated within the circumferential groove of the spring engagement section 804. This seating of the spring 802 into the circumferential groove could also be accomplished by a customer in order to retrofit a purchased assembly with the spring 802.

A method of using an elevator car door restrictor solenoid assembly that employs the plunger assembly 800 of FIG. 8 can comprise the steps of: (a) configuring a polarity of the solenoid 32 such that the plunger 138 extends from the solenoid 32 when the solenoid 32 is de-energized and retracts when the solenoid 32 is energized; and (b) selectively energizing and de-energizing the solenoid 32. The elevator car door restrictor solenoid assembly is thereby configured to operate both as a gravity-return plunger 138 when the elevator car door restrictor solenoid assembly is installed in a vertical orientation, and as a spring-return plunger 138 when the when the elevator car door restrictor solenoid assembly is installed in a horizontal orientation.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A one-piece solenoid bracket comprising:
a mounting web, the mounting web defining a first side and second side opposite the first side;
a first mounting flange extending from the first side substantially transversely to the mounting web;
a second mounting flange extending from the second side substantially transversely to the mounting web, the second mounting flange defining a flange end and a slot, the slot configured to accommodate a solenoid;
a retaining web extending from the flange end substantially transversely to the second mounting flange, the retaining web defining a distal end opposite the second mounting flange; and
a retaining flange, the retaining flange extending from the distal end substantially transversely to the retaining web opposite the second mounting flange;
wherein the mounting web, the first mounting flange, the second mounting flange, the retaining web, and the retaining flange form a single piece of material.

2. The one-piece solenoid bracket of claim 1, wherein the retaining flange defines a tool aperture, the tool aperture configured to accommodate a spacer attachment tool configured to attach a spacer to an end of a plunger positioned inside the solenoid.

3. The one-piece solenoid bracket of claim 1, wherein:
a first bend line defines the flange end of the second mounting flange, the first bend line extending between the second mounting flange and the retaining web, and
a second bend line defines the distal end of the retaining web, the second bend line extending between the retaining web and the retaining flange.

4. A solenoid plunger assembly, comprising:
a spacer comprising
a spacer body defining a first end, an opposed second end, and an axial bore extending from the first end to the second end, and
a head extending radially outwardly from the spacer body proximate the first end; and
a fastener extending through the axial bore, the fastener defining external threads configured to threadably engage a seat formed into an end of a solenoid plunger positioned within a solenoid.

5. The solenoid plunger assembly of claim 4, wherein the fastener is a socket head cap screw.

6. The solenoid plunger assembly of claim 4, wherein the head defines a front surface and an opposed rear surface, and further comprising a spring engagement section, the spring engagement section comprising
an axial extension extending axially from the front surface of the head; and
a boss extending radially outwardly from the axial extension opposite the front surface of the head, the boss, the axial extension, and the front surface of the head together defining a circumferential groove.

7. The solenoid plunger assembly of claim 6, wherein the boss radially terminates in a circumferential shoulder, and wherein the boss further defines a sloped profile extending radially inwardly from the circumferential shoulder, the sloped profile configured to engage a leading end of a spring, and to cause radial expansion of the leading end of the spring as the leading end of the spring moves along the sloped profile until the leading end of the spring finishes moving along the sloped profile and becomes seated within the circumferential groove.

8. An elevator car door restrictor solenoid assembly, comprising:
a one-piece solenoid bracket comprising
a mounting web, the mounting web defining a first side and second side opposite the first side,
a first mounting flange extending from the first side substantially transversely to the mounting web,
a second mounting flange extending from the second side substantially transversely to the mounting web, the second mounting flange defining a flange end and a slot,
a retaining web extending from the flange end substantially transversely to the second mounting flange, the retaining web defining a distal end opposite the second mounting flange, and
a retaining flange, the retaining flange extending from the distal end substantially transversely to the retaining web opposite the second mounting flange,
wherein the mounting web, the first mounting flange, the second mounting flange, the retaining web, and the retaining flange form a single piece of material;
a solenoid positioned within the slot defined in the second mounting flange;
a plunger axially moveable within the solenoid, the plunger defining an end, the end defining a fastener seat, and
a plunger assembly, comprising
a spacer comprising
a spacer body defining a first end, an opposed second end, and an axial bore extending from the first end to the second end, and
a head extending radially outwardly from the spacer body proximate the first end; and
a fastener extending through the axial bore, the fastener defining an externally-threaded end portion threadably engaging the fastener seat of the plunger.

9. The elevator car door restrictor solenoid assembly of claim 8, wherein the fastener is a socket head cap screw.

10. The elevator car door restrictor solenoid assembly of claim 8, wherein:
a first bend line defines the flange end of the second mounting flange, the first bend line extending between the second mounting flange and the retaining web, and
a second bend line defines the distal end of the retaining web, the second bend line extending between the retaining web and the retaining flange.

11. The elevator car door restrictor solenoid assembly of claim 8, wherein the head of the spacer defines a front surface and an opposed rear surface, and further comprising a spring engagement section, the spring engagement section comprising
an axial extension extending axially from the front surface of the head; and
a boss extending radially outwardly from the axial extension opposite the front surface of the head, the boss, the axial extension, and the front surface of the head together defining a circumferential groove.

12. The elevator car door restrictor solenoid assembly of claim 11, wherein the boss radially terminates in a circumferential shoulder, and wherein the boss further defines a sloped profile extending radially inwardly from the circumferential shoulder.

13. The elevator car door restrictor solenoid assembly of claim 12, further comprising a spring attached to the boss;
wherein the sloped profile is configured to allow an end of the spring to move axially rearwardly relative to the boss and to radially expand until the end of the spring becomes seated within the circumferential groove.

14. A method of using the elevator car door restrictor solenoid assembly of claim 13, comprising the steps of:
configuring a polarity of the solenoid such that the plunger extends from the solenoid when the solenoid is de-energized and retracts when the solenoid is energized; and
selectively energizing and de-energizing the solenoid;
wherein the elevator car door restrictor solenoid assembly is configured to operate both as a gravity-return plunger when the elevator car door restrictor solenoid assembly is installed in a vertical orientation, and as a spring-return plunger when the when the elevator car door restrictor solenoid assembly is installed in a horizontal orientation.

15. A method of assembling an elevator car door restrictor solenoid assembly, comprising the steps of:
partially inserting a externally-threaded reduced diameter portion of a solenoid partially through a hole of a one-piece solenoid bracket, the one-piece solenoid bracket comprising
a mounting web, the mounting web defining a first side and second side opposite the first side,
a first mounting flange extending from the first side substantially transversely to the mounting web, the first mounting flange defining the hole through which the externally-threaded reduced diameter portion of the solenoid is partially inserted;
a second mounting flange extending from the second side substantially transversely to the mounting web, the second mounting flange defining a flange end and a slot,
a retaining web extending from the flange end substantially transversely to the second mounting flange, the retaining web defining a distal end opposite the second mounting flange, and
a retaining flange, the retaining flange extending from the distal end substantially transversely to the retaining web opposite the second mounting flange,
wherein the mounting web, the first mounting flange, the second mounting flange, the retaining web, and the retaining flange form a single piece;
orienting the solenoid at an angle with respect to the mounting web;
exerting force upon the solenoid sufficient to position it within the slot of the second mounting flange and to orient an axis of the solenoid substantially parallel to a plane at least partially defined by the mounting web; and
substantially completely inserting the externally-threaded reduced diameter portion of the solenoid through the hole of the one-piece solenoid bracket.

16. The method of claim 15, further comprising the step of mounting a nut upon a portion of the externally-threaded reduced diameter portion of the solenoid extending through the hole of the one-piece solenoid bracket 17. The method of claim 15, further comprising the step of attaching a plunger assembly to a plunger axially moveable within the solenoid.

18. The method of claim 17, wherein the plunger defines an end, the end defining a fastener seat, and wherein the step of attaching the plunger assembly to the plunger comprises the steps of:
positioning a spacer between an end of the solenoid and the retaining flange, the spacer comprising
a spacer body defining a first end, an opposed second end, and an axial bore extending from the first end to the second end, and
a head extending radially outwardly from the spacer body proximate the first end;
inserting a fastener through the axial bore, the fastener defining opposed ends and external threads proximate at least one of the ends; and
threadably engaging the external threads of the fastener with the fastener seat.
